(19) United States
(12) Patent Application Publication
(10) Pub. No.: US 2026/0121347 A1
(43) Pub. Date: Apr. 30, 2026

(54) Connector Shroud Assembly for a Hermaphroditic Connector Assembly

(71) Applicant: Ciena Corporation, Hanover, MD (US)

(72) Inventors: Maxwell Thomas McKerlie, Richmond (CA); Victor Aldea, Ottawa (CA)

(21) Appl. No.: 18/930,364

(22) Filed: Oct. 29, 2024

(51) Int. Cl. H01R 13/631; H01R 12/79; H01R 13/28; H01R 13/627; H01R 13/633; H01R 43/26

(52) U.S. Cl. CPC H01R 13/631; H01R 12/79; H01R 13/28; H01R 13/6273; H01R 13/633; H01R 43/26; H01R 2201/04

(57) ABSTRACT

A connector shroud assembly that serves to align the connectors of a hermaphroditic connector assembly during mating, locking the mated connectors together and preventing relative motion (i.e., translation, rotation, and pivoting) between the connectors, especially (but not exclusively) when one of the connectors is coupled to a flexible ribbon or the like. The connector shroud assembly, which is disposed around and between the mated connectors, includes locking features that engage corresponding locking features of each of the connectors, thereby securing the connectors in the hermaphroditic connector assembly together. This provides a good pin connection and prevents de-mating of the connectors over time, during assembly or due to subsequent handling.

### TECHNICAL FIELD

The present disclosure relates generally to the telecommunications, optical networking, and electronics fields. More particularly, the present disclosure relates to a connector shroud assembly for a hermaphroditic connector assembly.

### BACKGROUND

Hermaphroditic connector assemblies are regularly used in the telecommunications, optical networking, and electronics fields. These hermaphroditic connector assemblies typically include fine pitched, mirror image mezzanine connectors that are capable of mating to themselves. Each connector is typically coupled to a printed circuit board (PCB) or rigid component, such that when the connectors are mated together, the hermaphroditic connector assembly provides a rigid construct with a good pin connection. When one of the connectors is coupled to a flexible ribbon or the like, however, the connectors may be able to rotate or pivot with respect to each other and “walk out” along the long axis of the hermaphroditic connector assembly. This can cause a bad pin connection or full de-mating of the connectors over time, especially during assembly or due to subsequent handling.

The present background is provided as environmental context only. It will be readily apparent to those of ordinary skill in the art that the concepts and principles of the present disclosure may be implemented in other environmental contexts equally, without limitation.

### SUMMARY

The present disclosure provides a connector shroud assembly that serves to align the connectors of a hermaphroditic connector assembly during mating, locking the mated connectors together and preventing relative motion (i.e., translation, rotation, and pivoting) between the connectors, especially (but not exclusively) when one of the connectors is coupled to a flexible ribbon or the like. The connector shroud assembly, which is disposed around and between the mated connectors, includes locking features that engage corresponding locking features of each of the connectors, thereby securing the connectors in the hermaphroditic connector assembly together. This provides a good pin connection and prevents de-mating of the connectors over time, during assembly or due to subsequent handling.

The connector shroud assembly may be made of a rigid plastic material or the like and be sacrificial, including features that may be engaged with a tool to “snap” or “break” the connector shroud assembly off of the hermaphroditic connector assembly, thereby allowing the connectors to be de-mated when desired.

In some embodiments, the present disclosure provides a connector shroud assembly for a hermaphroditic connector assembly, the connector shroud assembly including a frame adapted to be disposed conformally around a first connector and a second connector of the connector assembly with the first connector and the second connector mated within an opening defined by the frame, where the frame includes an internal alignment feature that is adapted to engage an external alignment feature of each of the first connector and the second connector, where the frame further includes an internal locking feature that is adapted to engage an external locking feature of each of the first connector and the second connector, and where the internal alignment feature and the internal locking feature of the frame are adapted to prevent relative motion of the second connector with respect to the first connector when the first connector and the second connector are mated within the opening defined by the frame. In some embodiments, the internal alignment feature of the frame includes internal posts disposed at ends of the frame that are adapted to engage base slots of bases disposed at ends of each of the first connector and the second connector to align the frame with respect to each of the first connector and the second connector. In some embodiments, the internal locking feature of the frame includes internal ramps disposed at sides of the frame that are adapted to engage protruding structures disposed at sides of each of the first connector and the second connector to secure the frame with respect to each of the first connector and the second connector and secure the first connector to the second connector. The first connector and the second connector include corresponding pairs of connector alignment features and connector alignment recesses that are adapted to align the first connector with the second connector when the first connector and the second connector are mated within the opening defined by the frame. In some embodiments, the frame further includes one or more external visual indicators and/or visual recesses that serve to orient alignment of the frame onto/with the first connector and the second connector. In some embodiments, the frame is manufactured from a rigid plastic sacrificial material. In some embodiments, the frame defines one or more breakaway slots that are each adapted to receive a tool to “snap” or “break” the frame off of the connector assembly, thereby allowing the second connector to be de-mated from the first connector. The frame is a separate and distinct component from either of the first connector and the second connector. In some embodiments, the first connector is coupled to a printed circuit board and the second connector is coupled to a flexible ribbon.

In some embodiments, the present disclosure provides a network element including a first connector, a second connector, and a connector shroud assembly including a frame disposed conformally around the first connector and the second connector with the first connector and the second connector mated within an opening defined by the frame, where the frame includes an internal alignment feature that engages an external alignment feature of each of the first connector and the second connector, where the frame further includes an internal locking feature that engages an external locking feature of each of the first connector and the second connector, and where the internal alignment feature and the internal locking feature of the frame prevent relative motion of the second connector with respect to the first connector when the first connector and the second connector are mated within the opening defined by the frame. In some embodiments, the internal alignment feature of the frame includes internal posts disposed at ends of the frame that engage base slots of bases disposed at ends of each of the first connector and the second connector to align the frame with respect to each of the first connector and the second connector. In some embodiments, the internal locking feature of the frame includes internal ramps disposed at sides of the frame that engage protruding structures disposed at sides of each of the first connector and the second connector to secure the frame with respect to each of the first connector and the second connector and secure the first connector to the second connector. The first connector and the second connector include corresponding pairs of connector alignment features and connector alignment recesses that align the first connector with the second connector when the first connector and the second connector are mated within the opening defined by the frame. In some embodiments, the frame further includes one or more external visual indicators and/or visual recesses that serve to orient alignment of the frame onto/with the first connector and the second connector. In some embodiments, the frame is manufactured from a rigid plastic sacrificial material. In some embodiments, the frame defines one or more breakaway slots that are each adapted to receive a tool to “snap” or “break” the frame off of the connector assembly, thereby allowing the second connector to be de-mated from the first connector. The frame is a separate and distinct component from either of the first connector and the second connector. In some embodiments, the first connector is coupled to a printed circuit board of the network element and the second connector is coupled to a flexible ribbon of the network element.

In some embodiments, the present disclosure provides a method for using a connector shroud assembly for a hermaphroditic connector assembly, the method including disposing a frame of a connector shroud assembly conformally around a first connector of the connector assembly, and disposing a second connector of the connector assembly conformally within the frame opposite the first connector, the first connector and the second connector mating within an opening defined by the frame, where the frame includes an internal alignment feature that engages an external alignment feature of each of the first connector and the second connector, where the frame further includes an internal locking feature that engages an external locking feature of each of the first connector and the second connector, and where the internal alignment feature and the internal locking feature of the frame prevent relative motion of the second connector with respect to the first connector when the first connector and the second connector are mated within the opening defined by the frame. In some embodiments, the method also includes inserting a tool into a breakaway slot defined in the frame that is adapted to receive the tool and “snapping” or “breaking” the frame off of the connector assembly, thereby allowing the second connector to be de-mated from the first connector.

It will be readily apparent to those of ordinary skill in the art that aspects and features of each of the described embodiments may be incorporated, omitted, and/or combined as desired in a given application, without limitation.

### BRIEF DESCRIPTION OF THE DRAWINGS

The present disclosure is illustrated and described with reference to the various drawings, in which like reference numbers are used to denote like assembly components/method steps, as appropriate, and in which:

FIG. 1 illustrates one embodiment of the hermaphroditic connector assembly and network element of the present disclosure utilizing one embodiment of the connector shroud assembly of the present disclosure;

FIG. 2 further illustrates one embodiment of a connector of the hermaphroditic connector assembly of FIG. 1 in multiple views;

FIG. 3 further illustrates the connector shroud assembly of FIG. 1 in multiple views;

FIG. 4 further illustrates the hermaphroditic connector assembly and the connector shroud assembly of FIG. 1;

FIG. 5 further illustrates the hermaphroditic connector assembly and the connector shroud assembly of FIG. 1 in cross-section;

FIG. 6 further illustrates the hermaphroditic connector assembly and the connector shroud assembly of FIG. 1 in cross-section;

FIG. 7 illustrates the sacrificial nature of the connector shroud assembly of FIG. 1; and

FIG. 8 illustrates one embodiment of the hermaphroditic connector assembly installation and removal method of the present disclosure utilizing the connector shroud assembly of FIG. 1.

It will be readily apparent to those of ordinary skill in the art that aspects and features of each of the illustrated embodiments may be incorporated, omitted, and/or combined as desired in a given application, without limitation.

### DETAILED DESCRIPTION

Again, the present disclosure provides a connector shroud assembly that serves to align the connectors of a hermaphroditic connector assembly during mating, locking the mated connectors together and preventing relative motion (i.e., translation, rotation, and pivoting) between the connectors, especially (but not exclusively) when one of the connectors is coupled to a flexible ribbon or the like. The connector shroud assembly, which is disposed around and between the mated connectors, includes locking features that engage corresponding locking features of each of the connectors, thereby securing the connectors in the hermaphroditic connector assembly together. This provides a good pin connection and prevents de-mating of the connectors over time, during assembly or due to subsequent handling.

The connector shroud assembly may be made of a rigid plastic material or the like and be sacrificial, including features that may be engaged with a tool to “snap” or “break” the connector shroud assembly off of the hermaphroditic connector assembly, thereby allowing the connectors to be de-mated when desired.

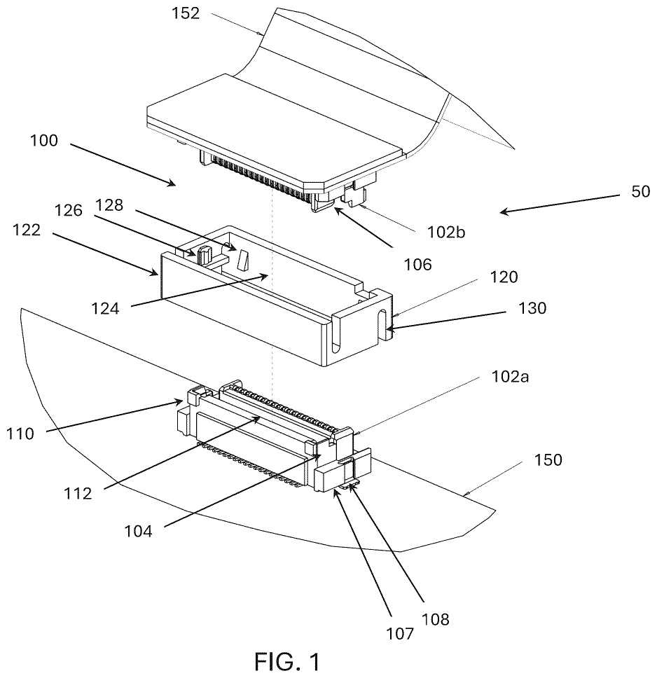

FIG. 1 illustrates one embodiment of the network element 50 and hermaphroditic connector assembly 100 of the present disclosure utilizing one embodiment of the connector shroud assembly 120 of the present disclosure. The connector assembly 100 includes a first connector 102a that is coupled to a PCB 150 (or rigid or flexible structure or component) and a second connector 102b that is coupled to a flexible ribbon 152 (or rigid or flexible structure or component). As alluded to above, the first connector 102a and the second connector 102b are fine pitched, mirror image mezzanine connectors that are capable of mating to themselves. When the second connector 102b is coupled to the flexible ribbon 152, for example, the second connector 102b may be able to rotate or pivot with respect to the first connector 102a and “walk out” along the long axis of the connector assembly 100. This can cause a bad pin connection or full de-mating of the connectors 102a, 102b over time, especially during assembly or due to subsequent handling.

Thus, the connector shroud assembly 120 provides a frame 122 defining an opening 124 that receives the first connector 102a and the second connector 102b and is disposed around the mated connectors 102a, 102b. This serves to align the connectors 102a, 102b during mating, locking the mated connectors 102a, 102b together and preventing relative motion (i.e., translation, rotation, and pivoting) between the connectors 102a, 102b.

In general, the first connector 102a and the second connector 102b each include connector alignment features 104 that are adapted to engage corresponding connector alignment recesses 106 of the other of the first connector 102a and the second connector 102b when the connectors 102a, 102b are mated, thereby aligning the connectors 102a, 102b with one another. These alignment features 104 and alignment recesses 106 may be conventional or may be provided as part of the connectors 102a, 102b and connector assembly 100 of the present disclosure. The first connector 102a and the second connector 102b each also include a base 107 that includes a base slot 108 at each end of the associated connector 102a, 102b, as well as protruding structures 110 disposed along the upper edge of the associated connector 102a, 102b. Again, these base slots 108 and protruding structures 110 may be conventional or may be provided as part of the connectors 102a, 102b and connector assembly 100 of the present disclosure. The fine pitched pins 112 are disposed centrally along the long axis of each of the connectors 102a, 102b.

The frame 122 of the connector shroud assembly 120 defining the opening 124 that receives the first connector 102a and the second connector 102b and is disposed around the mated connectors 102a, 102b is made of a rigid plastic material or the like. In the embodiment illustrated, the frame 122 is a substantially hollow prismatic rectangular structure, although other suitable structures and shapes may be used equally. The frame 122 includes multiple internal posts 126 that are adapted to engage the corresponding base slots 108 of the connectors 102a, 102b, such that the connectors 102a, 102b may be readily aligned with the connector shroud assembly 120. As described in greater detail below, these internal posts 126 and base slots 128 may be dovetailed to prevent relative movement/rotation of the frame 122 and connectors 102a, 102b with respect to one another. The frame 122 also includes multiple internal ramps 128 that are adapted to engage the corresponding protruding structures 110 of the connectors 102a, 102b, such that the connectors 102a, 102b are locked within the connector shroud assembly 120 after alignment with and insertion into the frame 122. These internal ramps 128 and/or the sides of the frame 122 are provided with a sufficient degree of flexibility such that the internal ramps 128 can be deflected and rebound to engage the corresponding protruding structures 110 of the connectors 102a, 102b. The frame 122 further includes multiple breakaway slots 130 that are adapted to receive a flathead tool or the like that is twisted to “snap” or “break” the connector shroud assembly 120 off of the connectors 102a, 102b, thereby allowing the connectors 102a, 102b of the connector assembly 100 to be de-mated when desired. Each of these features is described in greater detail below.

The connector shroud assembly 120 has minimal impact on the overall footprint of the hermaphroditic connector assembly 100 on the PCB 150. The placement area of the connectors 102a, 102b on the PCB 150 is defined by the associated pads. The connector shroud assembly 120 typically adds less than 1 mm length and width to the length and width of the connectors 102a, 102b, and the pads and electronic components on the PCB 150 are typically separated by more than 1 mm. Therefore, no significant new space constraints are typically experienced or caused by the connector shroud assembly 120.

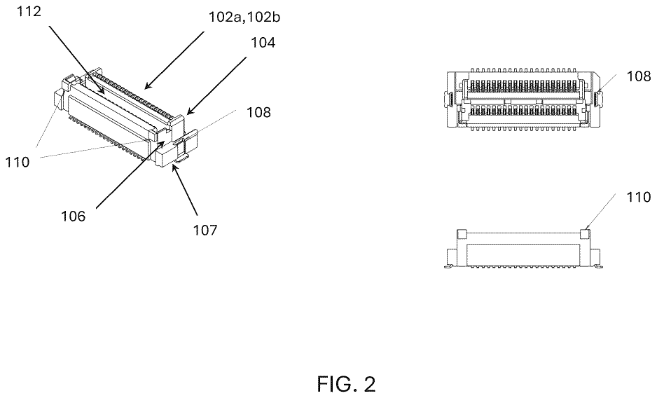

FIG. 2 further illustrates one embodiment of the connector 102a, 102b of the hermaphroditic connector assembly 100 of FIG. 1 in multiple views. Again, the first connector 102a and the second connector 102b each include the connector alignment features 104 that are adapted to engage the corresponding connector alignment recesses 106 of the other of the first connector 102a and the second connector 102b when the connectors 102a, 102b are mated, thereby aligning the connectors 102a, 102b with one another. These alignment features 104 and alignment recesses 106 are disposed at each end of the connectors 102a, 102b and may be conventional or may be provided as part of the connectors 102a, 102b and connector assembly 100 of the present disclosure. The first connector 102a and the second connector 102b each also include the base 107 that includes the base slot 108 at each end of the associated connector 102a, 102b, as well as the protruding structures 110 disposed along the upper edge of the associated connector 102a, 102b. The protruding structures 110 are provided on one side of each connector 102a, 102b, in mirror image with respect to the first connector 102a and the second connector 102b. Again, these base slots 108 and protruding structures 110 may be conventional or may be provided as part of the connectors 102a, 102b and connector assembly 100 of the present disclosure. The fine pitched pins 112 are disposed centrally along the long axis of each of the connectors 102a, 102b, integrated into and supported by the bases 107, which may both be parts of an integrated base structure 107.

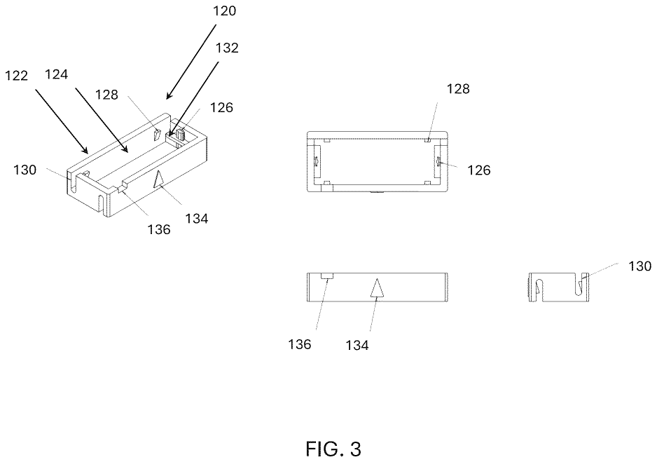

FIG. 3 further illustrates the connector shroud assembly 120 of FIG. 1 in multiple views. Again, the frame 122 of the connector shroud assembly 120 defining the opening 124 that receives the first connector 102a and the second connector 102b and is disposed around the mated connectors 102a, 102b is made of a rigid plastic material or the like. In the embodiment illustrated, the frame 122 is a substantially hollow prismatic rectangular structure, although other suitable structures and shapes may be used equally. The frame 122 includes the multiple internal posts 126 that are adapted to engage the corresponding base slots 108 of the connectors 102a, 102b, such that the connectors 102a, 102b may be readily aligned with the connector shroud assembly 120. In the embodiment illustrated, at each end of the frame 122, first and second internal posts 126 associated with the first and second connectors 102a, 102b, respectively. These first and second internal posts 126 are separated by an optional internal shelf structure 132 disposed at each end of the frame 122. The frame 122 also includes the multiple internal ramps 128 that are adapted to engage the corresponding protruding structures 110 of the connectors 102a, 102b, such that the connectors 102a, 102b are locked within the connector shroud assembly 120 after alignment with and insertion into the frame 122. The internal ramps 128 are provided on one side of each connector 102a, 102b, in mirror image with respect to the first connector 102a and the second connector 102b, corresponding to the mirror image protruding structures 110 of the first connector 102a and the second connector 102b. In this manner, the protruding structures 110 and internal ramps 128 lock the first connector 102a within the frame 122 on one side of the first connector 102a and the frame 122, and lock the second connector 102b within the frame 122 on the opposite side of the second connector 102b and the frame 122, as the first connector 102a and the second connector 102b are mated to one another in an opposed orientation. The frame 122 further includes the multiple breakaway slots 130 that are adapted to receive a flathead tool or the like that is twisted to “snap” or “break” the connector shroud assembly 120 off of the connectors 102a, 102b, thereby allowing the connectors 102a, 102b of the connector assembly 100 to be de-mated when desired. As illustrated, the outside of the frame 122 further includes one or more visual indicators 134 and/or visual recesses 136 that serve to orient the alignment of the connector shroud assembly 120 onto/with the connectors 102a, 102b.

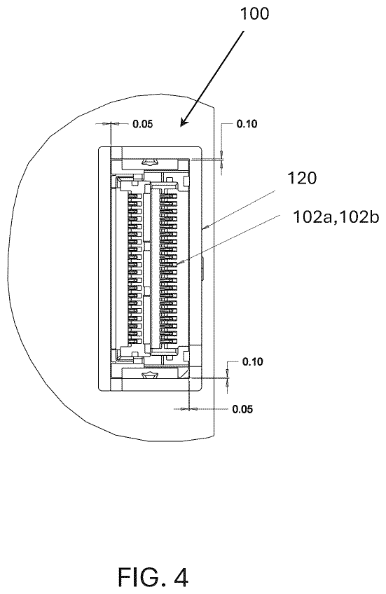

FIG. 4 further illustrates the hermaphroditic connector assembly 100 and the connector shroud assembly 120 of FIG. 1. As can be seen, the connector shroud assembly 120 surrounds the mated connectors 102a, 102b with a minimal gap (0.05-0.1 mm) to provide accurate alignment when mating the connectors 102a, 102b.

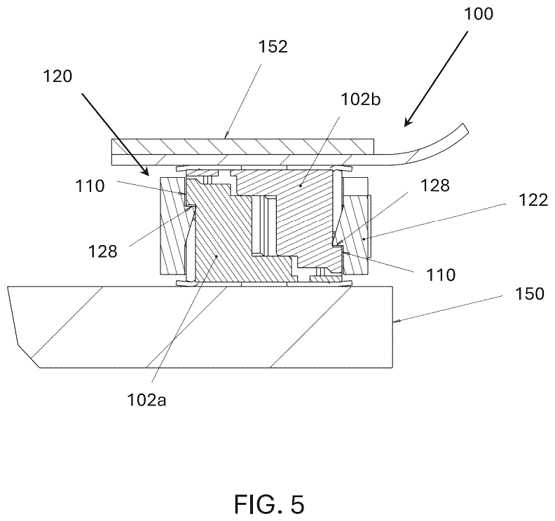

FIG. 5 further illustrates the hermaphroditic connector assembly 100 and the connector shroud assembly 120 of FIG. 1 in cross-section. The multiple internal ramps 128 of the frame 122 are shown engaging the corresponding protruding structures 110 of the connectors 102a, 102b, such that the connectors 102a, 102b are locked within the connector shroud assembly 120 after alignment with and insertion into the frame 122. The internal ramps 128 are provided on one side of each connector 102a, 102b, in mirror image with respect to the first connector 102a and the second connector 102b, corresponding to the mirror image protruding structures 110 of the first connector 102a and the second connector 102b. In this manner, the protruding structures 110 and internal ramps 128 lock the first connector 102a within the frame 122 on one side of the first connector 102a and the frame 122, and lock the second connector 102b within the frame 122 on the opposite side of the second connector 102b and the frame 122, as the first connector 102a and the second connector 102b are mated to one another in an opposed orientation. Here, the first connector 102a is coupled to the PCB 150 and the second connector 102b is coupled to the flexible ribbon 152, with the connector shroud assembly 120 preventing relative motion (i.e., translation, rotation, and pivoting) of the second connector 102b with respect to the first connector 102a.

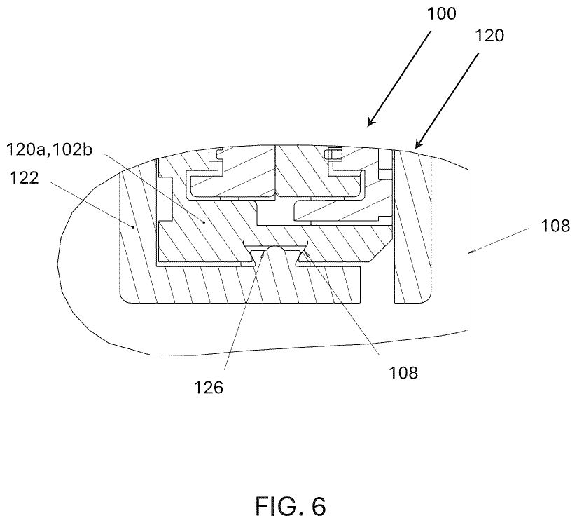

FIG. 6 further illustrates the hermaphroditic connector assembly 100 and the connector shroud assembly 120 of FIG. 1 in cross-section. In the embodiment illustrated, the internal posts 126 present within the frame 122 and the base slots 108 that receive the internal posts 126 are dovetailed, such that the components are held in rigid alignment with respect to one another, helping to ensure that the mated connectors 102a, 102b remain parallel once installed, thereby ensuring good pin engagement.

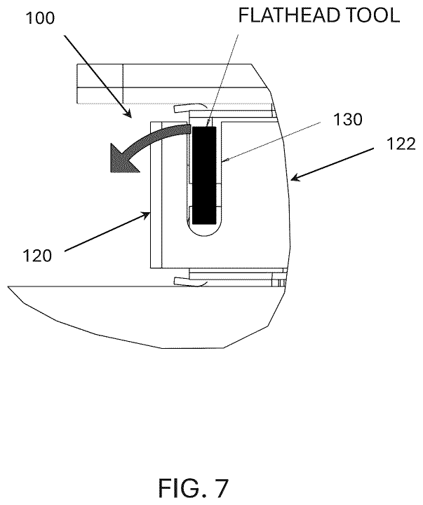

FIG. 7 illustrates the sacrificial nature of the connector shroud assembly 120 of FIG. 1. The frame 122 includes the multiple breakaway slots 130 that are adapted to receive the flathead tool or the like that is twisted to “snap” or “break” the connector shroud assembly 120 off of the connectors 102a, 102b, thereby allowing the connectors 102a, 102b of the connector assembly 100 to be de-mated when desired.

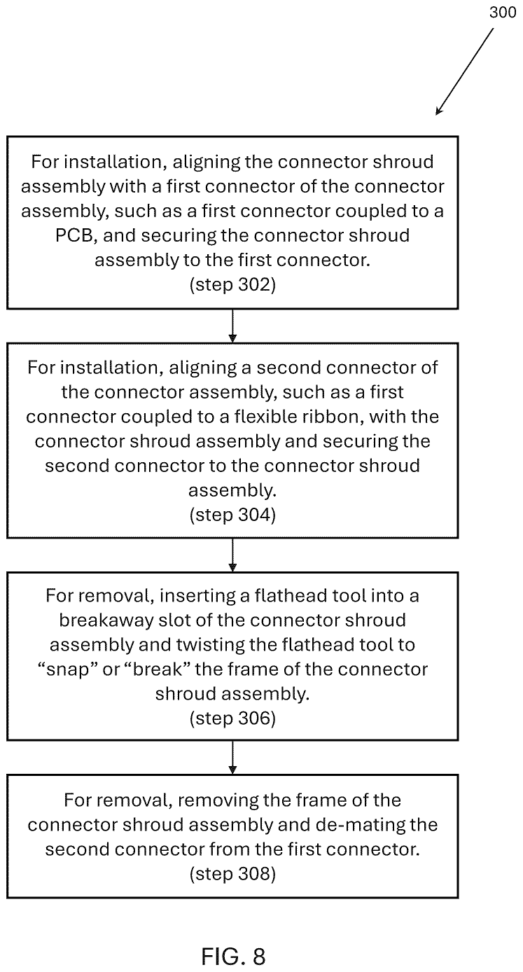

FIG. 8 illustrates one embodiment of the hermaphroditic connector assembly installation and removal method 300 of the present disclosure utilizing the connector shroud assembly 120 of FIG. 1. In terms of installation, first, the method 300 includes aligning the connector shroud assembly with a first connector of the connector assembly, such as a first connector coupled to a PCB, and securing the connector shroud assembly to the first connector (step 302). Next, the method 300 includes aligning a second connector of the connector assembly, such as a first connector coupled to a flexible ribbon, with the connector shroud assembly and securing the second connector to the connector shroud assembly (step 304). These alignments may be aided by the visual indicators provided on the outside of the connector shroud assembly. At this point, the connector assembly is secured by the connector shroud assembly with the connectors in full pin contact, with relative motion (i.e., translation, rotation, and pivoting) constrained by the connector shroud assembly. In terms of removal, first, the method 300 includes inserting a flathead tool into a breakaway slot of the connector shroud assembly and twisting the flathead tool to “snap” or “break” the frame of the connector shroud assembly (step 306). Next, the method 300 includes removing the frame of the connector shroud assembly and de-mating the second connector from the first connector (step 308).

Thus, again, the present disclosure provides a connector shroud assembly that serves to align the connectors of a hermaphroditic connector assembly during mating, locking the mated connectors together and preventing relative motion (i.e., translation, rotation, and pivoting) between the connectors, especially (but not exclusively) when one of the connectors is coupled to a flexible ribbon or the like. The connector shroud assembly, which is disposed around and between the mated connectors, includes locking features that engage corresponding locking features of each of the connectors, thereby securing the connectors in the hermaphroditic connector assembly together. This provides a good pin connection and prevents de-mating of the connectors over time, during assembly or due to subsequent handling. The connector shroud assembly has a minimal footprint on a PCB as compared to other connector locking mechanisms and does not reduce available placement room on the PCB.

The connector shroud assembly may be made of a rigid plastic material or the like and be sacrificial, including features that may be engaged with a tool to “snap” or “break” the connector shroud assembly off of the hermaphroditic connector assembly, thereby allowing the connectors to be de-mated when desired.

Although the present disclosure is illustrated and described with reference to specific embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A connector shroud assembly for a hermaphroditic connector assembly, the connector shroud assembly comprising
a frame adapted to be disposed conformally around a first connector and a second connector of the connector assembly with the first connector and the second connector mated within an opening defined by the frame,
wherein the frame comprises an internal alignment feature that is adapted to engage an external alignment feature of each of the first connector and the second connector, and
wherein the internal alignment feature of the frame is adapted to prevent relative motion of the second connector with respect to the first connector when the first connector and the second connector are mated within the opening defined by the frame.

2. The connector shroud assembly of claim 1, wherein the internal alignment feature of the frame comprises internal posts of the frame that are adapted to engage base slots of bases of the first connector and the second connector to align the frame with respect to each of the first connector and the second connector.

3. The connector shroud assembly of claim 1, wherein the frame further comprises an internal locking feature that is adapted to engage an external locking feature of each of the first connector and the second connector, and wherein the internal alignment feature and the internal locking feature of the frame are adapted to prevent relative motion of the second connector with respect to the first connector when the first connector and the second connector are mated within the opening defined by the frame.

4. The connector shroud assembly of claim 3, wherein the internal locking feature of the frame comprises internal ramps disposed at sides of the frame that are adapted to engage protruding structures disposed at sides of each of the first connector and the second connector to secure the frame with respect to each of the first connector and the second connector and secure the first connector to the second connector.

5. The connector shroud assembly of claim 1, where the first connector and the second connector include corresponding pairs of connector alignment features and connector alignment recesses that are adapted to align the first connector with the second connector when the first connector and the second connector are mated within the opening defined by the frame.

6. The connector shroud assembly of claim 1, wherein the frame further comprises one or more external visual indicators and/or visual recesses that serve to orient alignment of the frame onto/with the first connector and the second connector.

7. The connector shroud assembly of claim 1, wherein the frame is manufactured from a rigid plastic sacrificial material and wherein the frame defines one or more breakaway slots that are each adapted to receive a tool to “snap” or “break” the frame off of the connector assembly, thereby allowing the second connector to be de-mated from the first connector.

8. The connector shroud assembly of claim 1, wherein the frame is a separate and distinct component from either of the first connector and the second connector.

9. The connector shroud assembly of claim 1, where the first connector is coupled to a printed circuit board and the second connector is coupled to a flexible ribbon.

10. A network element comprising
a printed circuit board;
a flexible ribbon;
a first connector coupled to the printed circuit board,
a second connector coupled to the flexible ribbon, and
a connector shroud assembly comprising a frame disposed conformally around the first connector and the second connector with the first connector and the second connector mated within an opening defined by the frame,
wherein the frame comprises an internal alignment feature that engages an external alignment feature of each of the first connector and the second connector, and
wherein the internal alignment feature of the frame prevents relative motion of the second connector with respect to the first connector when the first connector and the second connector are mated within the opening defined by the frame.

11. The network element of claim 10, wherein the internal alignment feature of the frame comprises internal posts of the frame that engage base slots of bases of the first connector and the second connector to align the frame with respect to each of the first connector and the second connector.

12. The network element of claim 10, wherein the frame further comprises an internal locking feature that engages an external locking feature of each of the first connector and the second connector, and wherein the internal alignment feature and the internal locking feature of the frame prevent relative motion of the second connector with respect to the first connector when the first connector and the second connector are mated within the opening defined by the frame.

13. The network element of claim 12, wherein the internal locking feature of the frame comprises internal ramps disposed at sides of the frame that engage protruding structures disposed at sides of each of the first connector and the second connector to secure the frame with respect to each of the first connector and the second connector and secure the first connector to the second connector.

14. The network element of claim 10, wherein the first connector and the second connector comprise corresponding pairs of connector alignment features and connector alignment recesses that align the first connector with the second connector when the first connector and the second connector are mated within the opening defined by the frame.

15. The network element of claim 10, wherein the frame further comprises one or more external visual indicators and/or visual recesses that serve to orient alignment of the frame onto/with the first connector and the second connector.

16. The network element of claim 10, wherein the frame is manufactured from a rigid plastic sacrificial material and wherein the frame defines one or more breakaway slots that are each adapted to receive a tool to “snap” or “break” the frame off of the connector assembly, thereby allowing the second connector to be de-mated from the first connector.

17. The network element of claim 10, wherein the frame is a separate and distinct component from either of the first connector and the second connector.

18. A method for using a connector shroud assembly for a hermaphroditic connector assembly, the method comprising
disposing a frame of a connector shroud assembly conformally around a first connector of the connector assembly, and
disposing a second connector of the connector assembly conformally within the frame opposite the first connector, the first connector and the second connector mating within an opening defined by the frame,
wherein the frame comprises an internal alignment feature that engages an external alignment feature of each of the first connector and the second connector, and
wherein the internal alignment feature of the frame prevents relative motion of the second connector with respect to the first connector when the first connector and the second connector are mated within the opening defined by the frame.

19. The method of claim 18, wherein the frame further comprises an internal locking feature that engages an external locking feature of each of the first connector and the second connector, and wherein the internal alignment feature and the internal locking feature of the frame prevent relative motion of the second connector with respect to the first connector when the first connector and the second connector are mated within the opening defined by the frame.

20. The method of claim 18, further comprising inserting a tool into a breakaway slot defined in the frame that is adapted to receive the tool and “snapping” or “breaking” the frame off of the connector assembly, thereby allowing the second connector to be de-mated from the first connector.
